(19) United States
(12) Patent Application Publication
(10) Pub. No.: US 2009/0299807 A1
(43) Pub. Date: Dec. 3, 2009

(54) SCHEDULING OPPORTUNITY PREVIEWER

(75) Inventors: Rainer Schiller, Redmond, WA (US); Nelson Chun Hin Siu, Kirkland, WA (US); Joshua Jones, Malden, MA (US); Daniel P. Costenaro, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/129,682

(22) Filed: May 30, 2008

(51) Int. Cl. G06Q 99/00

(52) U.S. Cl. 705/9

(57) ABSTRACT

Various technologies and techniques are disclosed for previewing and managing scheduling opportunities. A scheduling opportunity is received. A context of one or more surrounding appointments to the scheduling opportunity is retrieved. The scheduling opportunity is displayed with the context of the surrounding appointments, such as in a mini-calendar format. When the appointment is a recurrent appointment, the scheduling opportunity for the recurrent appointment is displayed with a context of the surrounding appointments.

### BACKGROUND

Personal information managers such as MICROSOFT® Outlook enable users to manage their contacts, calendar and tasks. With many such personal information managers, users can even send scheduling opportunities to other users, such as to request a meeting or other appointment with that person. Users can also accept or decline scheduling opportunities from other users based upon their current schedule, and have the accepted scheduling opportunities automatically added to their calendar.

When a new scheduling opportunity arrives, a user typically has to leave the scheduling opportunity window to go open his or her calendar. The user then navigates among the other appointments already on the calendar to determine whether the new appointment being requested is acceptable or not. The user then returns to the scheduling opportunity and accepts, rejects, or proposes a new time for the scheduling opportunity.

### SUMMARY

Various technologies and techniques are disclosed for previewing and managing scheduling opportunities. A scheduling opportunity is received. A context of one or more surrounding appointments to the scheduling opportunity is retrieved. The scheduling opportunity is displayed with the context of the surrounding appointments, such as in a mini-calendar format.

In one implementation, when the appointment is a recurrent appointment, the scheduling opportunity for the recurrent appointment is displayed with a context of the surrounding appointments. The user can then navigate among the instances of the recurrent appointments from within the scheduling opportunity.

In another implementation, the mini calendar format is displayed when adding a new scheduling opportunity. A request is received from a user to create a new scheduling opportunity. The new scheduling opportunity is created. Within the new scheduling opportunity, context of surrounding appointments to the new scheduling opportunity is displayed in a mini-calendar format.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a scheduling opportunity previewer of one implementation.

FIG. 2 is a process flow diagram for one implementation illustrating the stages involved in displaying a scheduling opportunity with a context of surrounding appointments.

FIG. 3 is a process flow diagram for one implementation illustrating the stages involved in allowing a user to navigate between instances of a recurrent appointment from within the scheduling opportunity.

FIG. 4 is a process flow diagram for one implementation illustrating the stages involved in allowing a user to navigate among multiple conflicts from within the scheduling opportunity.

FIG. 5 is a process flow diagram for one implementation illustrating the stages involved in allowing a user to view and manage the scheduling opportunity for a recurrent appointment.

FIG. 6 is a simulated screen for one implementation that illustrates displaying a scheduling opportunity in a preview pane.

FIG. 7 is a simulated screen for one implementation that illustrates displaying a scheduling opportunity in a separate window.

FIGS. 8 and 9 are simulated screens for one implementation that illustrates enabling a user to collapse and expand the mini-calendar format.

FIG. 10 is a simulated screen for one implementation that illustrates enabling a user to navigate among multiple instances of the scheduling opportunity.

FIG. 11 is a simulated screen for one implementation that illustrates enabling the user to navigate among conflicts that occur between multiple instances of the recurrent scheduling opportunity.

FIG. 12 is a diagrammatic view of a computer system of one implementation.

### DETAILED DESCRIPTION

The technologies and techniques herein may be described in the general context as an application displays and manages scheduling opportunities, but the technologies and techniques also serve other purposes in addition to these. In one implementation, one or more of the techniques described herein can be implemented as features within personal information management program such as MICROSOFT® Outlook, or from any other type of program or service that manages scheduling opportunities.

Current personal information managers allow users to send scheduling opportunities to other users to request a meeting or appointment. They also allow that same user to receive scheduling opportunities from other users. However, when the person receives a scheduling opportunity, they don't have a visual indication about when the meeting or appointment takes place, except usually for date and time. Furthermore, they don't see the scheduling information of other appointments if the appointment is in conflict or adjacent to other appointments unless they take additional steps, such as to open up their calendar.

In one implementation, a scheduling opportunity previewer is described that displays scheduling opportunities in a mini-calendar format that shows the user's calendar around the time of the appointment request. The term “scheduling opportunity” as used herein is meant to include a request to add a new appointment or meeting to a user's calendar. The term “mini-calendar format” as used herein is meant to include a miniature view of the user's calendar relative to a current context being considered. The mini-calendar format also shows conflicting and/or adjacent appointments. This allows the user to make an accept, decline, or propose new time decision without having to switch their context. In other words, the user does not have to open up their calendar module in order to make a decision on how to handle the current scheduling opportunity in their email inbox or other schedule queue. For recurrent appointments, the user can navigate from instance to instance as well as from conflicting instance to conflicting instance to make a scheduling decision.

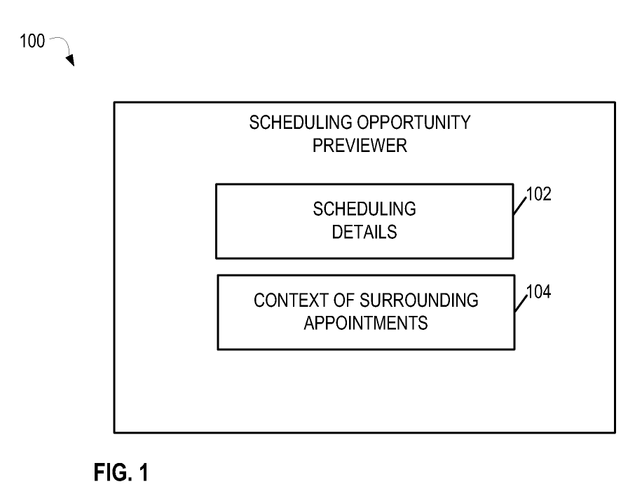

FIG. 1 is a diagrammatic view of a scheduling opportunity previewer 100 of one implementation. Scheduling opportunity previewer 100 displays the scheduling details 102 of the current scheduling opportunity, such as the date and time of the appointment. Scheduling appointment previewer 100 also displays the context of any surrounding appointments 104. In one implementation, a mini-calendar format is used to visually display the context of the surrounding appointments 104. This mini-calendar format enables the user to see the context of other appointments already scheduled that surround the scheduling opportunity being requested. In other words, the user is able to quickly see whether there are conflicts or adjacent appointments. This allows the user to quickly make decisions about whether to accept, decline, or propose a new time for the current scheduling opportunity, or to modify other appointments already on the calendar.

In another implementation, textual or other descriptions can be used to describe the context of the surrounding appointments 104 instead of or in addition to the mini-calendar format. When such textual descriptions are used, the appointments that occur prior to and after the scheduling opportunity being requested can be displayed so the user can make a decision on whether or not to accept the scheduling opportunity from within the scheduling opportunity.

In one implementation, scheduling opportunity previewer 100 can also be used when the user is adding a new scheduling opportunity to his or her own calendar. In such an implementation, scheduling opportunity previewer 100 receives a request from the user to create a new scheduling opportunity, such as upon user selection of an option to add a new appointment. A new scheduling opportunity is then created that the user can edit. The context of the surrounding appointments is displayed in a mini-calendar format from within the new scheduling opportunity. This allows the user to see the other appointments that are adjacent to or conflicting with the new appointment being added so the user does not have to leave the new appointment being created to go navigate through his/her calendar to see if there are other appointments to take into consideration.

In another implementation, scheduling opportunity previewer 100 displays the context of surrounding appointments for multiple users. In other words, the mini-calendar format can be displayed for multiple team members, or for multiple calendars of the same user.

In yet another implementation, the user can propose a new time for another scheduling opportunity that has already been confirmed, because a scheduling conflict has now arisen due to the current scheduling opportunity.

In yet another implementation, the user is able to select an alternative schedule for the scheduling opportunity and preview the impact of the alternative schedule before sending it to another user. The alternative schedule is then displayed (graphically or otherwise) for the user to review before the alternative schedule is sent as a new proposal to the other user. In other words, the alternative schedule can be displayed in the mini-calendar format, or another suitable format. This preview capability allows the user to determine whether the alternative schedule will work for the user's calendar before sending the proposal to a other user.

In one implementation, by previewing various details from within the scheduling opportunity itself, the user is saved from having to go to a separate calendar module to view the details of his/her calendar to make informed decisions.

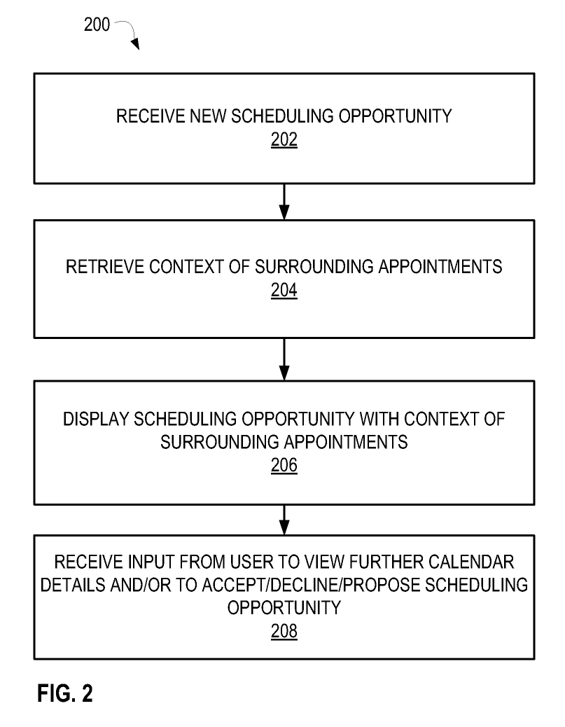

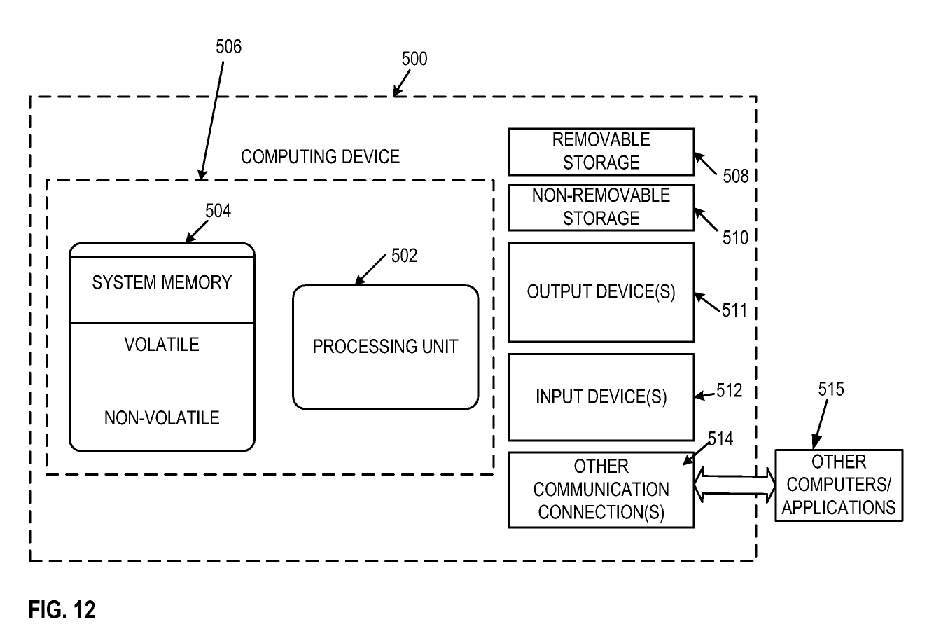

Turning now to FIGS. 2-11, the stages for implementing one or more implementations of scheduling opportunity previewer 100 are described in further detail. In some implementations, the processes of FIG. 2-11 are at least partially implemented in the operating logic of computing device 500 (of FIG. 12).

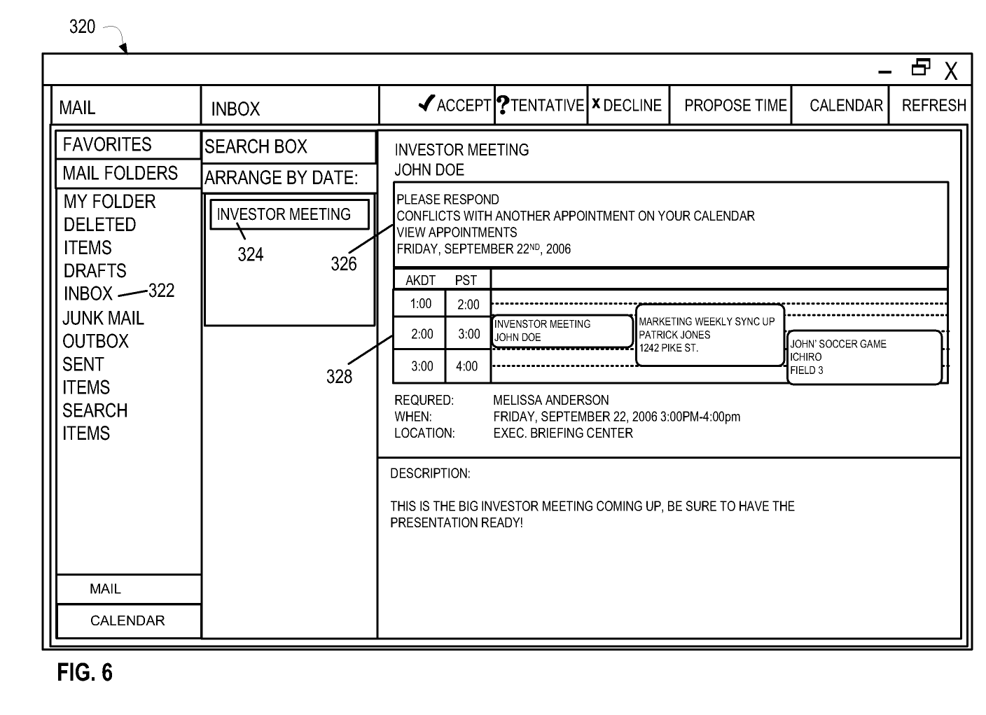

FIG. 2 is a process flow diagram 200 for one implementation illustrating the stages involved in displaying a scheduling opportunity with a context of surrounding appointments. A new scheduling opportunity is received (stage 202), such as in an e-mail inbox or other scheduling queue of the user. An example of a scheduling opportunity being received in an email inbox of the user is illustrated in FIG. 6. The context of surrounding appointments for the new scheduling opportunity is retrieved (stage 204). The context of the surrounding appointments can include adjacent appointments and/or conflicting appointments, to name a few examples.

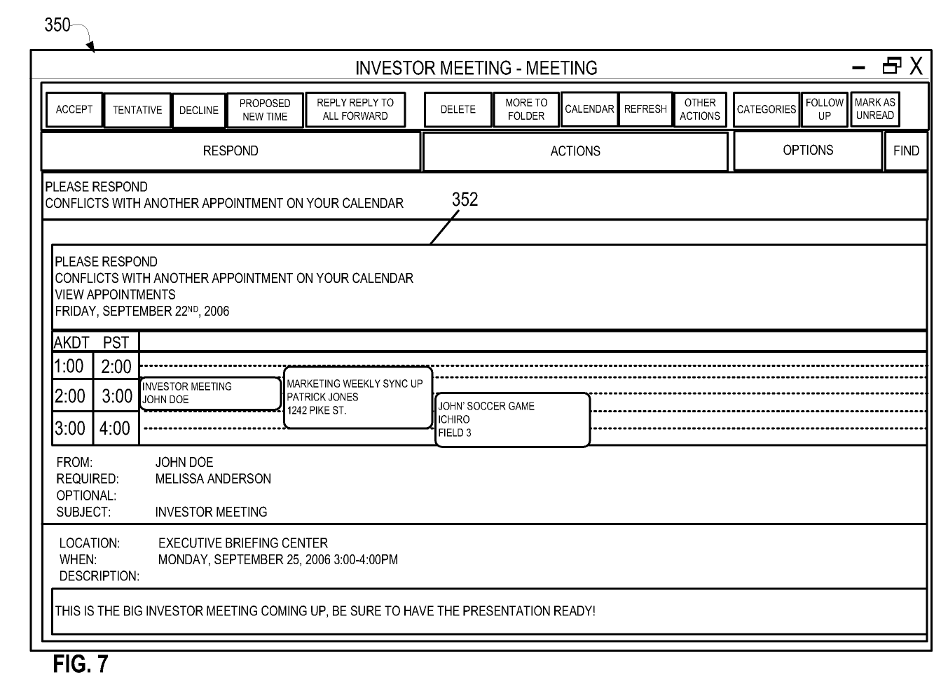

The scheduling opportunity is displayed along with the context of the surrounding appointments (stage 206). Conflicts between the current scheduling opportunity and any existing appointments can be indicated with a visual or other indictor to bring the issue to the user's attention. The scheduling opportunity can be displayed in a preview pane (as shown in FIG. 6), or in a separate window (as shown in FIG. 7), as a few non-limiting examples. In one implementation, the scheduling opportunity is displayed in a mini-calendar format. This mini-calendar format allows the user to visually see whether or not there are conflicts or adjacent appointments to the current scheduling opportunity. An example of the mini-calendar format is shown in FIGS. 6-11.

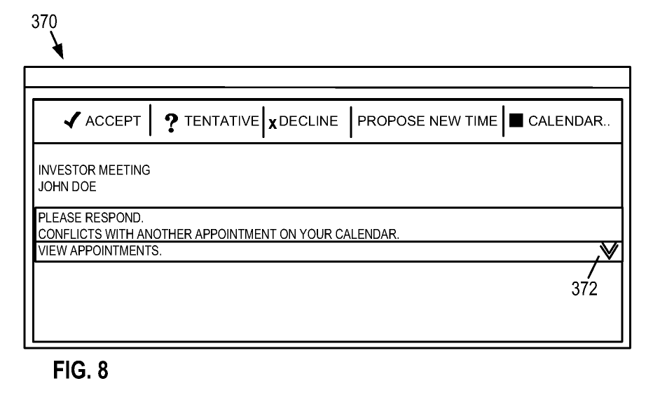

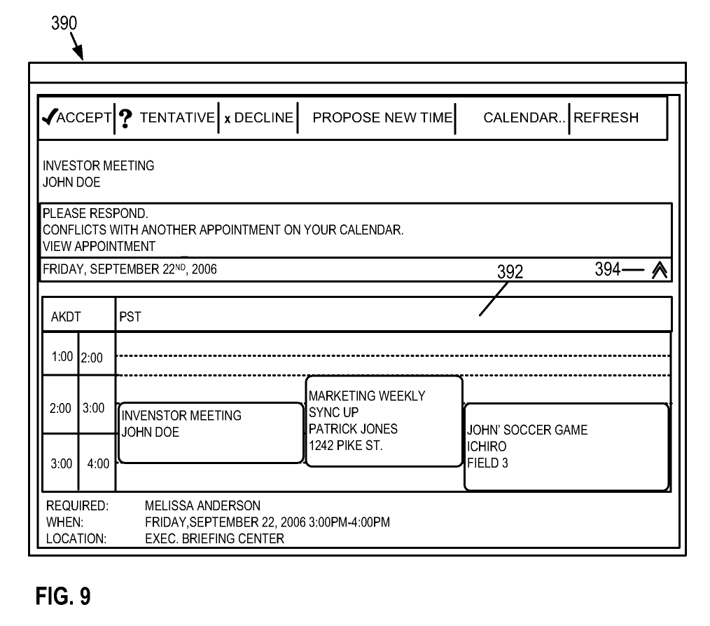

Alternatively or additionally to the mini-calendar format, a textual or other description of the context of surrounding appointments can be provided. Input is received from the user to further view the details and/or to accept, decline, or propose a new time for the current scheduling opportunity (stage 208) or for other appointments already on the calendar. In one implementation, the user can also collapse and expand the mini-calendar format as desired to toggle the feature on or off, as shown in FIGS. 8 and 9. In one implementation, the user can adjust the size of the mini-calendar format.

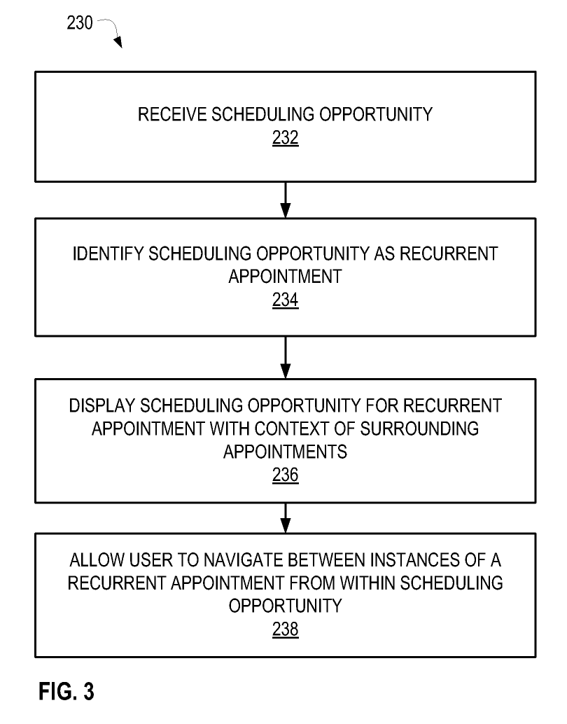

FIG. 3 is a process flow diagram 230 for one implementation illustrating the stages involved in allowing a user to navigate between instances of a recurrent appointment from within the scheduling opportunity. A scheduling opportunity is received (stage 232), and the scheduling opportunity is identified as a recurrent appointment (stage 234). A recurrent appointment is an appointment that takes place over multiple separate appointment dates/times. For example, a recurrent appointment might include a weekly team meeting that occurs every Friday at 2:30 pm.

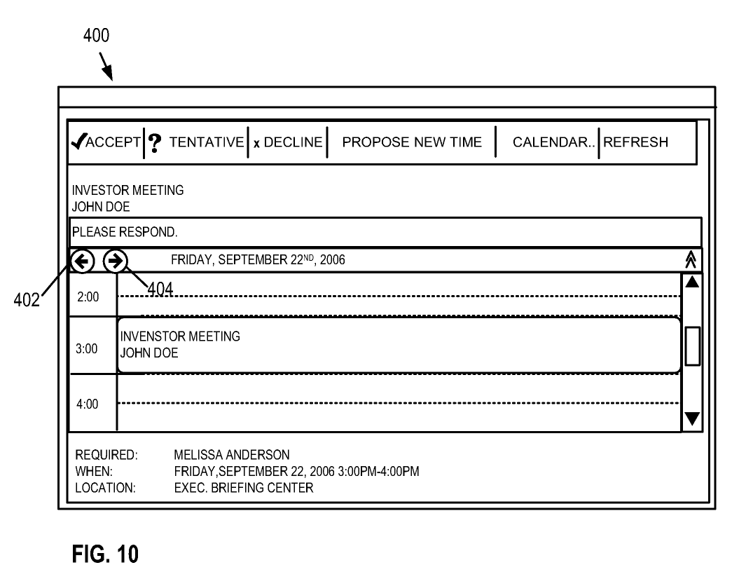

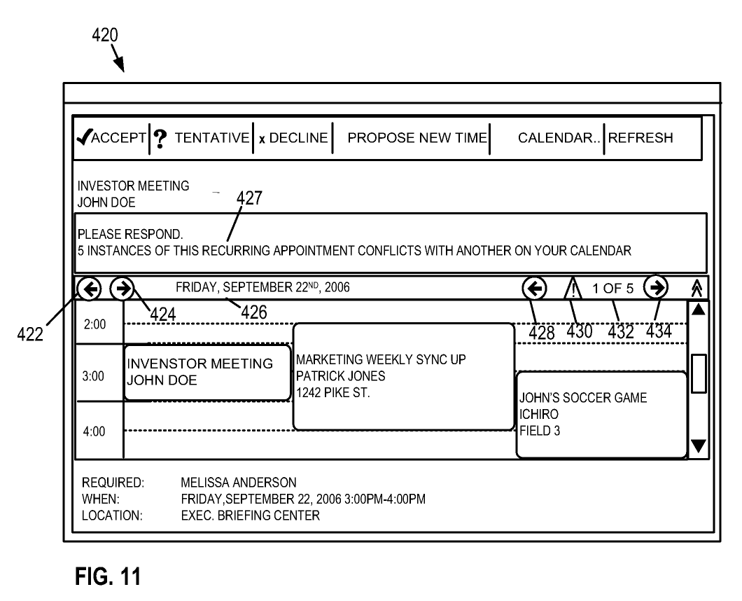

The scheduling opportunity is displayed for the recurrent appointment with the context of the surrounding appointments (stage 236). The user is able to navigate between instances of the recurrent appointment from within the scheduling opportunity (stage 238). In other words, the user can navigate through the mini-calendar format or other indicator to see the context of the surrounding meetings for each instance of the recurrent appointment. An example of a scheduling opportunity for a recurrent appointment that does not have conflicts is shown in FIG. 10. An example of a scheduling opportunity for a recurrent appointment that does have conflicts as shown in FIG. 11.

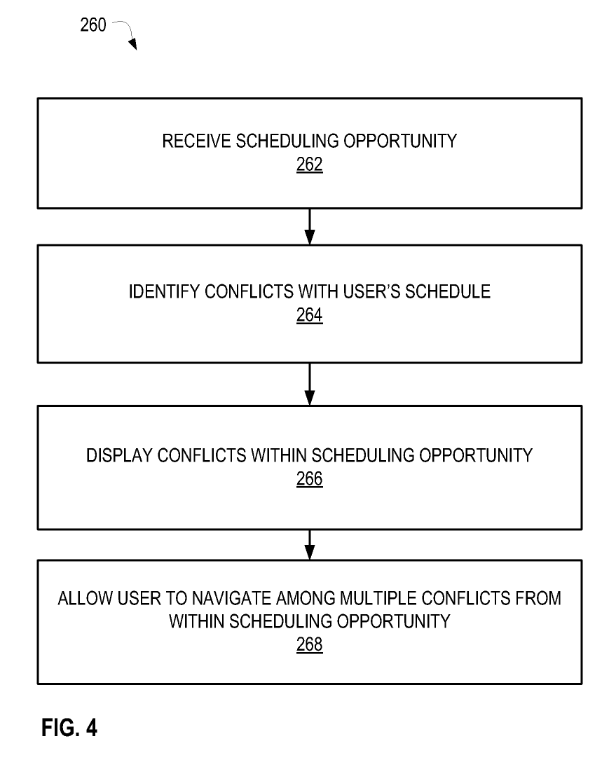

FIG. 4 is a process flow diagram 260 for one implementation illustrating the stages involved in allowing a user to navigate among multiple conflicts from within the scheduling opportunity. A scheduling opportunity is received (stage 262). Conflicts are identified with the user's schedule (stage 264). Conflicts are displayed within the scheduling opportunity (stage 266). The user is able to navigate among multiple conflicts from within the scheduling opportunity (stage 268).

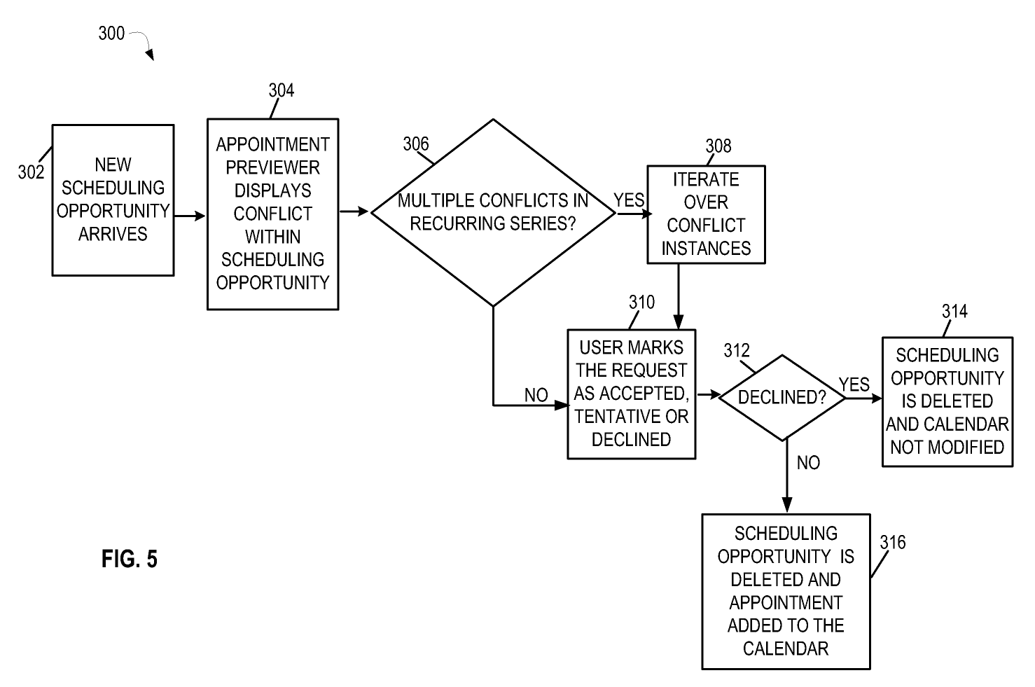

FIG. 5 is a process flow diagram 300 for one implementation illustrating the stages involved in allowing a user to view and manage the scheduling opportunity for a recurrent appointment with conflicts. When a new scheduling opportunity arrives (stage 302), the appointment previewer displays the conflict within the scheduling opportunity (stage 304). If there are multiple conflicts in the recurring series (decision point 306), then the system iterates over multiple conflict instances (stage 308). If there are not multiple conflicts in the recurring series (decision point 306), then the user can mark the request as accepted, tentative, or declined. If the scheduling opportunity is declined (decision point 312), then the scheduling opportunity is deleted and the calendar of the user is not modified (stage 314). If the scheduling opportunity is not declined (decision point 312), and the scheduling opportunity is deleted and the appointment is added to the user's calendar (stage 316).

FIG. 6 is a simulated screen 320 for one implementation that illustrates displaying a scheduling opportunity in a preview pane. In the example shown, the scheduling opportunity 324 is displayed in a preview pane 326 within the user's e-mail inbox. In the example shown, a mini-calendar format 328 is displayed to allow the user to visually see the context of surrounding appointments.

FIG. 7 is a simulated screen 350 for one implementation that illustrates displaying a scheduling opportunity 352 in a separate window. In one implementation, the user can open the scheduling opportunity from the e-mail inbox and view it in this expanded view in a separate window to see additional details.

FIGS. 8 and 9 are simulated screens for one implementation that illustrates enabling a user to collapse and expand the mini-calendar format. For example, simulated screen 370 of FIG. 8 illustrates a collapsed view of the mini-calendar format. The user can expand the mini-calendar format by selecting the expand option 372. Simulated screen 390 of FIG. 9 illustrates an expanded view of mini-calendar format 392. To collapse the mini-calendar format 392, the user can select the collapse option 394.

FIG. 10 is a simulated screen 400 for one implementation that illustrates enabling a user to navigate among multiple instances of the scheduling opportunity. In the example shown, the scheduling opportunity is a recurrent appointment. This particular scheduling opportunity does not have conflicts with any existing appointments. Navigation options 402 and 404 enable the user to navigate among the multiple instances of the recurrent appointment. This enables the user to determine whether the particular recurrent appointment introduces multiple scheduling conflicts, and helps the user determine whether to propose a new time, or whether to accept or decline the current scheduling opportunity.

FIG. 11 is a simulated screen 420 for one implementation that illustrates enabling the user to navigate among conflicts that occur between multiple instances of the recurrent scheduling opportunity. In this example, the scheduling opportunity is also a recurrent appointment, as is indicated by the navigation options 422 and 424. The date of this recurring appointment is also indicated 426.

In this particular example, a visual indicator 430 and a separate textual description 427 are both displayed to inform the user that there are multiple instances of this recurring appointment that have a conflict with other items on the calendar currently. Conflict navigation arrows 428 and 434 allow the user to navigate among the multiple instances of the conflicts that have been identified. The conflict position indicator 432 indicates that the user is currently viewing the first of five conflicts that occur with the current scheduling opportunity.

As shown in FIG. 12, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 12 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 12 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for providing a scheduling opportunity previewer comprising the steps of:
receiving a scheduling opportunity;
retrieving a context of one or more surrounding appointments to the scheduling opportunity; and
displaying the scheduling opportunity with the context of surrounding appointments.

2. The method of claim 1, further comprising the steps of:
receiving input from a user to view further calendar details.

3. The method of claim 1, further comprising the steps of:
receiving input from a user to accept or decline the scheduling opportunity.

4. The method of claim 1, wherein the displaying of the scheduling opportunity includes a mini-calendar format.

5. The method of claim 4, wherein the mini-calendar format is shown in an e-mail preview pane.

6. The method of claim 4, wherein the mini-calendar format is shown in a separate window.

7. The method of claim 4, wherein the mini-calendar format can be toggled on and off.

8. The method of claim 4, wherein the mini-calendar format can be adjusted in size.

9. The method of claim 1, wherein any conflicts occurring between the scheduling opportunity and the surrounding appointments are indicated visually.

10. The method of claim 1, wherein when multiple conflicts occur between a scheduling opportunity and the surrounding appointments, allowing a user to navigate among the multiple conflicts

11. The method of claim 1, wherein the scheduling opportunity is received in an inbox.

12. The method of claim 11, wherein the inbox is an email inbox.

13. The method of claim 1, wherein the context of surrounding appointments is shown for multiple users.

14. The method of claim 1, further comprising the steps of:
from within the scheduling opportunity, receiving input from a user to propose a new time for a scheduling conflict that has now arisen with another scheduling opportunity already confirmed.

15. The method of claim 1, further comprising the steps of.
receiving input from a user to select an alternative schedule for the scheduling opportunity; and
displaying the alternative schedule graphically for the user to review before sending the alternative schedule as a new proposal.

16. A method for managing scheduling conflicts with recurrent appointments comprising the steps of:
receiving a scheduling opportunity;
identifying the scheduling opportunity as a recurrent appointment; and
displaying the scheduling opportunity for the recurrent appointment with a context of surrounding appointments.

17. The method of claim 16, wherein, further comprising the steps of:
receiving input from a user to navigate between instances of the recurrent appointment from within the scheduling opportunity.

18. The method of claim 16, wherein the displaying of the scheduling opportunity for the recurrent appointment includes a mini-calendar format.

19. A computer-readable medium having computer-executable instructions for causing a computer to perform steps comprising:
receiving a request from a user to create a new scheduling opportunity; and
creating the new scheduling opportunity; and
within the new scheduling opportunity, displaying a context of surrounding appointments to the new scheduling opportunity in a mini-calendar format.

20. The computer-readable medium of claim 19, wherein the request is a user selection of an option to create the new scheduling opportunity for a selected calendar.
